(19) United States
(12) Patent Application Publication
(10) Pub. No.: US 2003/0234975 A1
(43) Pub. Date: Dec. 25, 2003

(54) Banded optical amplifier

(76) Inventors: John D. Minelly, Painted Post, NY (US); Mark R. Munch, Elmira, NY (US); James R. Passalugo, Big Flats, NY (US); Laura A. Weller-Brophy, Corning, NY (US)

Correspondence Address: VOLENTINE FRANCOS, P.L.L.C., Suite 150, 12200 Sunrise Valley Drive, Reston, VA, 20191, US

(21) Appl. No.: 10/178,801

(22) Filed: Jun. 24, 2002

(51) Int. Cl. H01S 3/00

(52) U.S. Cl. 359/337.1

(57) ABSTRACT

An optical amplifier includes a demultiplexer which separates a broadband optical signal into a plurality of banded optical signals; a plurality of ports, each of which outputs a selected one of the plurality of banded optical signals; and an amplifier section which is coupled to one of the plurality of output ports.

A method of amplifying a optical signal includes separating a broadband optical signal into a plurality of banded optical signals; providing a plurality of ports, each of which outputs a selected one of said plurality of banded optical signals; and coupling an amplifier section to one of said plurality of ports.

### FIELD OF THE INVENTION

The present invention relates generally to optical communications systems, and specifically to a banded optical amplifier.

### BACKGROUND

The increasing demand for high-speed voice and data communications has led to an increased reliance on optical communications, especially optical fiber communications. The use of optical signals as a vehicle to carry channeled information at high speed is preferred in many instances to carrying channeled information at other electromagnetic wavelengths/frequencies in media such as microwave transmission lines, coaxial cable lines, and twisted copper pair transmission lines.

Advantages of optical media include higher channel capacities (bandwidth), greater immunity to electromagnetic interference, and lower propagation loss. In fact, it is common for high-speed optical systems to have signal rates in the range of approximately several megabits per second (Mbit/s) to approximately several tens of gigabits per second (Gbit/s), and greater.

In order to meet the ever-increasing demand for faster transmission rates, system providers have looked to increase the spectral bandwidth. To attempt to meet this desired end, ever increasing transmission bands have been specified. However, most of the capacity of these transmission bands has gone under-utilized by many users. For example, many optical components and modules have bandwidth capabilities that are not completely utilized by many users.

One optical component that typically has bandwidth capabilities greater than the typical user calls into play in the optical amplifier. For purposes of illustration, it is common for an optical amplifier to provide gain over a 30 nm bandwidth. However, many users require amplification over a relatively small portion of this gain band (e.g., 25% to 30% of the gain band).

While the foresight of the amplifier designers may be beneficial in the future as a greater portion of the gain spectrum of many amplifiers is utilized this capacity is realized at a price. To this end, it is typically required that the amplifier provide certain characteristics over the gain band. These requirements include gain flatness over the band, which is illustratively better than 0.5 dB over a 30 nm to 50 nm band in many ultra-long haul applications.

To meet gain flatness requirements over a relatively wide bandwidth, additional, distributed gain flattening may be needed over the optical network, and which can require a variety of components. As can be appreciated, these components increase the complexity and cost of the optical amplifier and of the optical network in which they are deployed. In essence, these requirements add to the complexity and cost of optical amplifiers to enable a wide gain bandwidth, when this bandwidth is not currently utilized nearly to its capacity in the first place.

Accordingly, what is needed is an optical amplifier that overcomes at least the drawbacks associated with known devices described above.

### SUMMARY

In accordance with an exemplary embodiment of the present invention, an optical amplifier includes a demultiplexer which separates a broadband optical signal into a plurality of banded optical signals; a plurality of ports, each of which outputs a selected one of the plurality of banded optical signals; and

an amplifier section which is coupled to one of the plurality of output ports.

In accordance with another exemplary embodiment, a method of amplifying a optical signal comprises: separating a broadband optical signal into a plurality of banded optical signals; providing a plurality of ports, each of which outputs a selected one of said plurality of banded optical signals; and coupling an amplifier section to one of said plurality of ports.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a functional block diagram of an amplifier architecture in accordance with an exemplary embodiment of the present invention.

FIG. 2 is a functional block diagram of an amplifier pump multiplexer/demultiplexer in accordance with an exemplary embodiment of the present invention.

FIG. 3 is a functional block diagram of an amplifier architecture in accordance with an exemplary embodiment of the present invention.

FIG. 4 is a functional block diagram of an amplifier architecture in accordance with an exemplary embodiment of the present invention.

FIG. 5 is a functional block diagram of an amplifier architecture in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

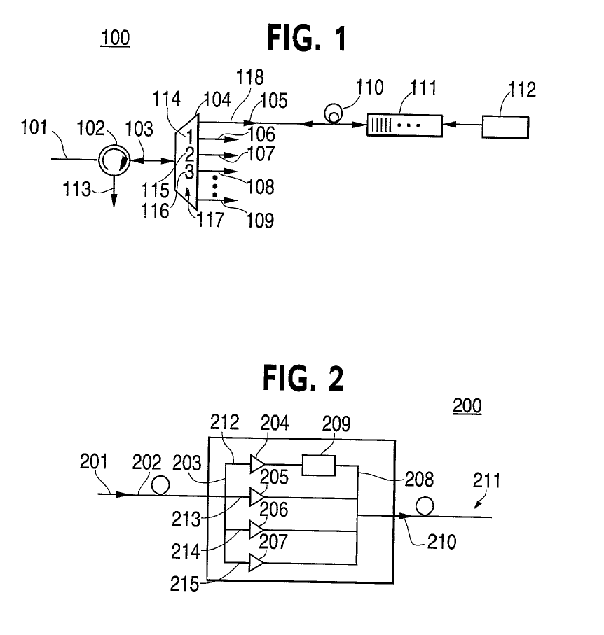

FIG. 1 shows an amplifier architecture 100 in accordance with an exemplary embodiment of the present invention. A three-port circulator 102 receives an input optical signal 101, which is illustratively a wavelength division multiplexed (WDM) or dense wavelength division multiplexer (DWDM) optical signal having a plurality of wavelength channels. The circulator 102 routes the input optical signal 101 into a multiplexer/demultiplexer (mux/demux) 104, which separates the input optical signal 101 in a selective manner.

Beneficially, the mux/demux 104 is a banded device that desirably introduces little if any chromatic dispersion to the input signal 105 or an amplified signal 103. Illustratively, the mux/demux 104 is an arrayed waveguide device, which can be used to demultiplex the broadband input optical signal 101 into bands or individual channels without creating deadbands. Advantageously, the use of an arrayed waveguide device affords low chromatic dispersion in an optical signal.

It is noted that other types of filter devices could be used for the mux/demux 104. These can be based on thin-film technology, although care must be taken to avoid introducing dispersion into the signal. Finally, it is noted that other technologies such as grating-based multiplexers/demultiplexers may be used. Advantageously, these alternative devices should be chosen to provide multiplexing/demultiplexing capability without introducing significant chromatic dispersion to the optical signal.

The mux/demux 104 illustratively separates the input optical signal into a plurality of separate output bands 105, 106, 107, 108 and 109, which are output via port 1 (114), port 2(115), port 3(116) and port n (117), respectively. The output bands 105-109 each include a subset of the wavelength channels of the input optical signal 101. At the lower limit, these output bands 105-109 may be single wavelength channels. For reasons that will become more clear as the present description proceeds, the wavelength bands of the output bands 105-109 are chosen to conform with the most common increment of bandwidth upgrade and to provide the optimal gain control of the laser without the need for complex gain flattening filters, which are required in known broadband amplifier architectures.

For purposes of illustration, and not limitation, the input optical signal 101 may include 40 optical wavelength channels. Illustratively, the mux/demux 104 may output ten output bands, with each output band including four wavelength channels. Of course, this is merely illustrative, and there may be fewer or more wavelength channels in the input optical signal 101 and in each of the output bands 105-109. Moreover, it is noted that in the description that follows, the output bands each include an equal number of wavelength channels, and the wavelength channels within each output band and from band to band are sequential (e.g., output band 105 illustratively includes wavelength channels 1-4, and output band 106 includes wavelength channels 5-9, etc.). However, this is not necessary to realize the amplifier architecture 100. In fact the number of wavelength channels in each output band need not be equal, nor does their ordering need to be sequential from output band to output band or within an output band.

The outputs of the mux/demux 104 may be selectively coupled to respective amplifier sections. As will become clearer as the present description continues, this fosters the ability to selectively amplify output bands as they are used, rather than to provide the capability to amplify a broadband signal when the user is not utilizing the entire spectrum. Ultimately this allows capital expenditures to be made for only the amplification bandwidth that is needed. Still other advantages are realized and described herein.

For purposes of illustration, only banded output 105 is amplified. To wit, in the presently described exemplary embodiment, the current need of a user may be for a band of four wavelength channels. Of course, this is merely illustrative, and other bands may be selectively amplified in a manner consistent with the described exemplary embodiments. The banded output is coupled to an optical fiber 114, which is coupled to a gain medium 110; illustratively an erbium doped optical fiber. The gain medium is tailored to the output band to be amplified. To this end, the gain medium is chosen to have a substantially flat gain across the selected output band. This enables the amplification to be relatively flat across the output band, thereby eliminating the need for gain-flattening devices (e.g., gain flattening filters (GFF)), which are costly, and which can adversely impact performance.

This is a benefit of the amplification architecture 100 of the present embodiment. To this end, in contrast to broadband amplification, amplifying a signal uniformly across a relatively narrow wavelength band is relatively straightforward. For example, it may be as simple as choosing a particular concentration of rare-earth dopants in the construction of the amplifying medium.

It is noted that a number of bands may be amplified in a selective manner. For example, instead of amplifying output band 105 alone, it may be useful to amplify output bands 105-108 (i.e., 16 wavelength channels in the presently described exemplary embodiment). In this case, it may be useful to have a fiber ribbon connection to effect coupling. Moreover, the gain medium 110 may be ribbonized erbium doped fibers, with each individual erbium fiber tailored to exhibit substantially flat gain across its particular output band. As referenced previously, this may be effected by the proper selection of the dopant concentration in the fiber, with Er noted for illustrative purposes. Finally, it is noted, that the selection of output bands to be amplified need not be sequential (e.g., output bands 105-107 and 109 may be connected to ribboned fibers).

After traversing the gain fiber 110, the banded output 105 is input to a dispersion compensator (DC) 111, through which the banded output 105 travels bi-directionally. Illustratively, the DC 111 is a chirped (linearly or non-linearly) reflective fiber Bragg grating (FBG). It is noted in this case that the fiber Bragg grating may be tunable; and that other types of gratings and dispersion compensators may be used. These alternative gratings are, for example those described in the following U.S. Patent Applications: ‘Chromatic Dispersion Control Using Index Variation (application Ser. No. 09/983,770, filed Oct. 25, 2001); ‘Chromatic Dispersion Control Method and Apparatus’ (application Ser. No. 09/983,769, filed Oct. 25, 2001); ‘Dynamic Chromatic Dispersion Control Using Coupled Waveguides’ (application Ser. No. 09/983,771, filed Oct. 25, 2001); ‘Monolithic Filter Array (application Ser. No. 10/099,089, filed Mar. 15, 2002); ‘Optical Filter Array and Method of Use’ (application Ser. No. 10/099,111, filed Mar. 15, 2002); and ‘Tunable Optical Filter Array and Method of Use’ (application Ser. No. 10/100,463, filed Mar. 15, 2002). The disclosures of the above referenced applications are specifically incorporated herein by reference. It is noted that in the event that coupled waveguides such as those of described in some of the above-referenced applications are used in DC 111, it may be useful to use a reflective device to return the output band 105 to the mux/demux 104. Moreover, it may be useful to ensure proper mode coupling in such a device.

The DC 111 provides dispersion compensation over the range of wavelengths of the output band 105. Because the wavelength range of the output band is small compared to a broadband spectrum, there are certain advantages afforded by the use of the DC 111 when compared to broadband compensators. For example, in broadband dispersion compensation, it is often difficult to provide adequate dispersion compensation over the entire wavelength band. However, by choosing a smaller range over which to provide compensation, the DC 111 may be tailored to provide compensation over the particular wavelength band (e.g., the wavelength band of output 105). Moreover, as it is often desired to amplify additional output bands (e.g. output bands 106-109), additional dispersion compensators (similar to DC 111) that are tailored to the wavelength range of their output band may be deployed.

Because the respective wavelength ranges of the individual output bands 105-109 are relatively small compared to a broadband signal (e.g. input optical signal 101), the residual dispersion slope across the output band 105 is nearly negligible, and therefore, does not require additional compensation. Of course, this is true for the other individual output bands 106-109. As such, it is normally unnecessary to provide dispersion slope compensation in the DC 111. It is noted that slope compensation is generally unnecessary for output bands up to several nm. For example, for an optical network having 50 GHz channel spacing, a 4 nm wavelength range corresponds to 10 channels. Providing dispersion compensation over wavelength bands up to approximately 4 nm permits the dispersion slope to be approximated by a ‘staircase’ function with residual dispersion slope errors on the order of or less than ±2.5 ps/nm per 100 km span. In long haul networks operating at 40 Gbps, these residual errors could be corrected on a per-channel basis at reconfiguration, transmitter, and/or receiver nodes. For long haul networks operating at 10 Gbps, these residual slope errors would cause negligible Q degradation of the received optical signals.

The segmentation of the broadband input signal 101 into a plurality of output bands, thereby provides yet another benefit compared to known broadband amplifier architectures. Specifically, the amplifier architecture 100 of an exemplary embodiment of the present invention generally does not require dispersion slope compensation. In contrast, known broadband amplifiers require dispersion slope compensation across the amplified bandwidth as residual dispersion slope can be on the order of approximately ±10 psec/nm to approximately ±25 psec/nm (and greater) after each amplification stage in deployed embedded fiber links. As can be readily appreciated, in a long haul optical link, this is unacceptably high, and must be compensated, which is a challenging task over a broadband wavelength spectrum. By comparison, in the amplifier architecture 100 of an exemplary embodiment of the present invention, because there is little if any residual dispersion slope over the output bands 105-109, dispersion slope compensation may be foregone.

In addition to providing dispersion compensation, the DC 111 may be used to reduce gain ripple across the output band 105. To this end, in accordance with an exemplary embodiment of the present invention in which the DC 111 is a chirped grating having a period that varies along the length. Thereby one end of the wavelength band (e.g., the ‘blue-end’) is reflected at the front end of the grating while the other end (e.g., longer wavelengths than the blue-end) is reflected at the back-end of the grating, and delayed longer. Moreover, the strength of the grating may be varied with wavelength. Thereby portions of the wavelength band of the grating may be reflected to greater or lesser efficiencies than others. This means that slight differences in gain across the output bands may be compensated for by the DC 111 by providing amplitude adjustment. Ultimately, this can be used to provide gain ripple compensation. Again, because of the segmentation of the broadband signal into smaller bands, this gain ripple compensation is more readily effected.

As referenced above, the output band 105 traverses the DC 111 bi-directionally. In the exemplary embodiment in which the DC is a reflective FBG, the output band 105 is reflected back to the gain medium 110 and the mux/demux 104. The bi-directional traversal of the output band 105 results in the light's passing through the gain medium 110 twice, as well as its being pumped co-directionally and contra-directionally by an optical pump 112. Usefully, in accordance with an exemplary embodiment of the present invention, the ‘double-passing’ of the gain medium by the signal leads to better power conversion efficiency in the amplifier as does the counter-propagating pump scheme. This efficiency gain is achieved in return for a modest noise figure penalty.

The output band 105 is then multiplexed with any other output band (e.g., one or more of output bands 106-109) that have been amplified by respective amplifier stages (not shown) to form amplified signal 103. The circulator routes amplified signal 103 as an output optical signal 113 to another segment of an optical link (not shown).

In addition to the advantages described thus far, and others that will be apparent to one of ordinary skill in the art, the exemplary embodiments of the present invention provide flexibility to the user, the ability to provide a desired amplification capacity, and the ability to upgrade this capacity on an as-needed basis. To wit, by virtue of the exemplary embodiments of the present invention, if one needs to amplify one banded signal, one needs to incorporate one optical pump and one DC. If further bands are desirably amplified, further pumps and DC's may be added to meet desired ends. As such capital expenditures may be made for needed capacity, and delayed until this capacity is desired.

Moreover, the banded amplification approach afforded by the exemplary embodiments of the present invention enables dispersion compensation to be carried out over a relatively short wavelength range. This is a significant improvement to broadband amplifiers that require expensive broadband dispersion compensators that may not provide adequate compensation over the relatively broad wavelength.

Additionally, it is noted that in accordance with an exemplary embodiment of the present invention, all banded signals (e.g. output bands 105-109) may be desirably amplified. This could be via upgrades over time or effected at the outset. In this embodiment it is readily appreciated that a broadband signal may be demultiplexed into narrower wavelength bands, amplified and multiplexed effectively to afford broadband amplification, without having to provide broadband dispersion compensators, gain flattening filters/devices, dispersion slope compensators, and ripple compensators. In addition to a potential reduction in the cost of the amplifier architecture, the ability to forego these elements potentially reduces Rayleigh backscattering, and thereby deleterious multi-path interference (MPI), which can adversely impact signal quality and performance.

In the amplifier architectures of the exemplary embodiments it may be useful to curb the ill-effects of Rayleigh scattering and MPI by the appropriate selection of the dopant concentration in the gain medium 110 and the length thereof as well. To this end, when using gain media/fibers with high dopant concentration it may be useful to limit their length, possibly with a low-numerical aperture to limit the capture fraction of back-scattered photons. As can be readily appreciated by one skilled in the art, this effect will be more pronounced at the extreme red wavelength spectrum where the gain per unit length is the lowest. Illustratively, if using an Er-doped fiber, a dopant concentration of approximately 3×10¹⁹cm⁻³ and a numerical aperture of approximately 0.1 can reduce MPI to acceptable levels.

A further benefit of several of the banded amplifier designs illustrated here is the elimination of the pump laser multiplexers. Typically, pump lasers are introduced into the optical amplifier using a pump multiplexer whereby a 980 nm pump laser or other appropriate pump laser wavelength is multiplexed onto the amplifier fiber together with the 1550 nm signal. For example, pump multiplexers may be foregone, and pump radiation introduced via a port in the dispersion compensating element (fiber grating, for example).

FIG. 2 shows an amplifier module 200 in accordance with an exemplary embodiment of the present invention. The amplifier module 200 includes many of the elements, features and benefits of the amplification architecture 100 of FIG. 1. As such, many of the common details will not be repeated in the interest of brevity of discussion. The amplifier module 200 includes an input optical waveguide 201 and an input optical signal 202, which may be a broadband WDM/DWDM optical signal. The input optical signal 202 is input to a demultiplexer 203 which is illustratively an AWG demux described above, and which segments the broadband input optical signal 202 into four banded signals. It is noted that the input optical signal 202 may be segmented into fewer or more banded signals than shown by the demultiplexer 203.

In the exemplary embodiment of FIG. 2, the amplifier module is presently configured to amplify a first banded signal 212. To this end, an optical pump 209 is coupled to a first amplifier medium 204; and the other banded signals, a second banded signal 213, a third banded signal 214 and a fourth banded signal 215, are coupled to a second gain medium 205, a third gain medium 206 and a fifth gain medium 207, respectively, which are not pumped. After amplification, the first banded signal 212 passes through multiplexer 208, which is illustratively an AWG mux referenced above. The output signal 210 is output via an output waveguide 211.

Advantageously, as it becomes desirable to amplify further bands, additional pumps (not shown) could be coupled to respective gain media. For example, if it were desired to amplify the third banded signal 214, another optical pump (not shown) would be coupled to third gain medium 206. Once amplified, the third band would be multiplexed with the other banded signal, and then output via output waveguide 211. Beneficially, this segmentation of the broadband input optical signal 202 enables one to upgrade a system when it is needed to amplify additional banded signals.

It is noted that the segmentation of the input optical signal 202 into first through fourth banded signals 212-215, respectively, enables amplification, while inherently overcoming the hurdles broadband dispersion compensation, or dispersion slope compensation, or both. Banded dispersion compensating elements similar to those described and illustrated in connection with the exemplary embodiment of FIG. 1 may be introduced into the banded amplifier module to effect dispersion compensation. It is important to note that the banded amplifier can be used without dispersion compensation as desired to optimize network performance.

FIGS. 3-5 show exemplary embodiments of the present invention. The embodiments shown in these figures share many common elements, features and advantages of the exemplary embodiment of FIG. 1. In general, these commonalities will not be discussed in detail and only differences elaborated upon.

FIG. 3 shows an amplifier architecture 300 in accordance with an exemplary embodiment of the present invention. An input optical signal 301, which is illustratively a broadband WDM/DWDM signal, is routed to a mux/demux 304 by a three-port circulator 302. A first output band 305 is selected to be amplified, while a plurality of remaining output bands 306-308 are not in the present embodiment; but could be selectively amplified via upgrading in a manner described above.

The first output band 305 is coupled to a pump multiplexer/demultiplexer (hereinafter pump mux) 310, which is coupled to a an optical pump 309. The pump mux 310 is illustratively a 980 nm/1550 nm multiplexer/demultiplexer well known in to one of ordinary skill in the art.

The first output band 305 then traverses a gain medium 311, and undergoes selective reflection and dispersion compensation via a dispersion compensator 312. An optical tap 313 may be used for performance analysis and a feedback control architecture (not shown). In a manner similar to that described in connection with the embodiment of FIG. 1, an amplified output signal 303 is routed as an output signal 314 by the circulator 302.

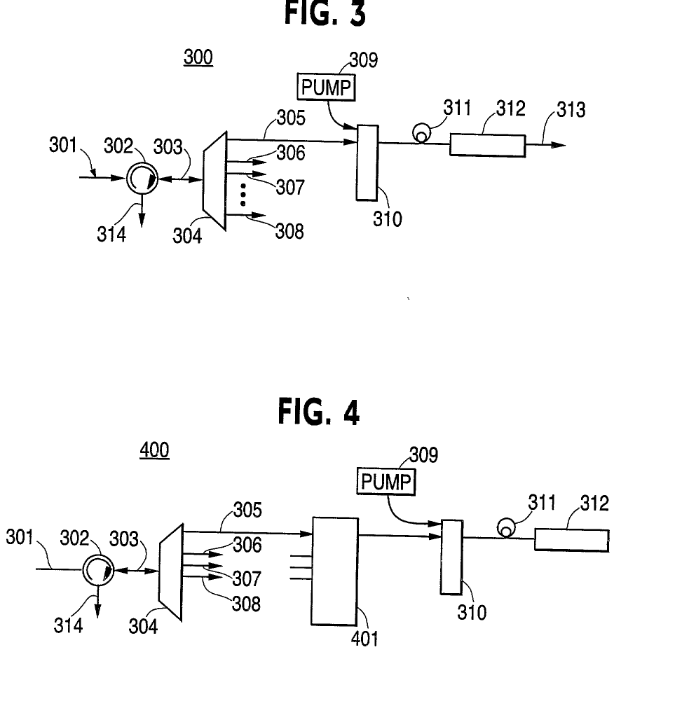

FIG. 4 shows a variation of the exemplary embodiment of FIG. 3. In this exemplary embodiment, an amplifier architecture 400 includes an array tap 401 in the gain fabric to facilitate selective sampling of optical signals. The may be advantageous if the DC 312 is replaced by a 100% broadband reflector.

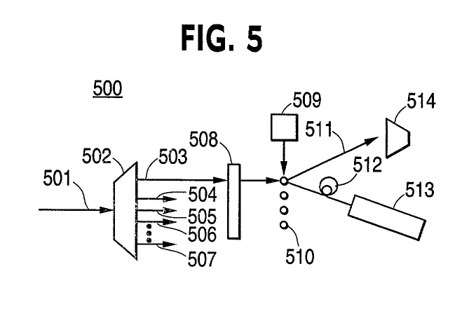

FIG. 5 shows another exemplary embodiment of the present invention. An amplifier architecture 500 in accordance differs from the embodiments of FIGS. 1, 3 and 4 in that the amplified signal is not routed through the input. This may be useful to further reduce MPI. An input optical signal (DWDM/WDM) 501 is demultiplexed by demux 502. First output band 503 is amplified, while output bands 504-507 are not at in this illustrative embodiment. The first output band is coupled to an arrayed filter, which prevents reflection of light of the pump 509 from being reflected an adding to MPI. The first output band 503 is then coupled to an arrayed circulator 510, which couples the first output band 503 through a gain medium 512, and DC 513. The arrayed circulator couples the amplified output band 511 to a multiplexer 514.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An optical amplifier, comprising:
a demultiplexer which separates a broadband optical signal into a plurality of banded optical signals;
a plurality of ports, each of which is adapted to output a selected one of said plurality of banded optical signals; and
an amplifier section coupled to one of said plurality of ports.

2. An optical amplifier as recited in claim 1, wherein said amplifier section includes a dispersion compensator.

3. An optical amplifier as recited in claim 2, wherein said dispersion compensator is a reflective optical grating.

4. An optical amplifier as recited in claim 3, wherein said reflective optical grating is a Bragg grating.

5. An optical amplifier as recited in claim 1, wherein said amplifier section does not include a gain-flattening device.

6. An optical amplifier as recited in claim 1, wherein each of said banded optical signals has a finite wavelength range that is a segment of a wavelength range of said broadband optical signal.

7. An optical amplifier as recited in claim 6, wherein said amplifier section includes a gain medium chosen to provide substantially flat gain across said finite wavelength range.

8. An optical amplifier as recited in claim 1, wherein at least one other amplifier section is coupled to a another of said ports.

9. An optical amplifier as recited in claim 1, wherein an amplified output signal is output from the optical amplifier substantially free of gain tilt and gain ripple.

10. An optical amplifier as recited in claim 1, wherein at least two of said ports are coupled to a ribboned optical fiber, which has a plurality of gain fibers, each of which is chosen to provide substantially flat gain across a wavelength range of a respective one of said plurality of banded optical signals.

11. An optical amplifier as recited in claim 1, further comprising a plurality of amplifier sections, each of which is coupled to a respective one of said ports.

12. An optical amplifier as recited in claim 11, wherein each of said plurality of amplifiers sections has a gain medium chosen to provide a substantially flat gain across a wavelength range of a respective one of said plurality of banded optical signals.

13. An optical amplifier as recited in claim 1, wherein said broadband optical signal includes n optical channels, and said plurality of optical ports equals m, where n and m are integers.

14. An optical amplifier as recited in claim 13, wherein said plurality of banded optical signals equals n/m.

15. An optical amplifier as recited in claim 1, wherein each of said plurality of banded optical signals includes at least two channels having a channel spacing chosen from the group consisting essentially of: 12.5 GHz, 25 GHz, 50 GHz, 100 GHz, 200 GHz and 400 GHz.

15. An optical amplifier as recited in claim 14, where n=40 and m=4.

16. An optical amplifier as recited in claim 13, wherein said plurality of banded optical signals does not equal n/m.

17. An optical amplifier as recited in claim 2, wherein said dispersion compensator includes a coupled fiber structure.

18. An optical amplifier as recited in claim 1, wherein the amplifier output an amplified signal that has substantially no chromatic dispersion or dispersion slope.

19. An optical amplifier as recited in claim 1, wherein said amplifier section further comprises a pump multiplexer.

20. A method of amplifying a optical signal, the method comprising:
separating a broadband optical signal into a plurality of banded optical signals;
providing a plurality of ports, each of which outputs a selected one of said plurality of banded optical signals; and
coupling an amplifier section to one of said plurality of ports.

21. A method as recited in claim 20, further comprising providing a dispersion compensator in said amplifier section.

22. A method as recited in claim 20, wherein the method further comprises not providing a gain flattening device.

23. A method as recited in claim 20, wherein each of said banded optical signals has a finite wavelength range that is a segment of a wavelength range of said broadband optical signal.

24. A method as recited in claim 20, further comprising providing a plurality of amplifier sections, each of which is coupled to a respective one of said ports.

25. A method as recited in claim 24, wherein each of said plurality of amplifiers sections has a gain medium chosen to provide a substantially flat gain across a wavelength range of a respective one of said plurality of banded optical signals.

26. A method as recited in claim 20, wherein said broadband optical signal includes n optical channels, and said plurality of optical ports equals m, where n and m are integers.

27. A method as recited in claim 26, wherein said plurality of banded optical signals equals n/m.

28. A method as recited in claim 26, wherein said plurality of banded optical signals does not equal n/m.
